(19) United States
(12) Patent Application Publication
(10) Pub. No.: US 2016/0112825 A1
(43) Pub. Date: Apr. 21, 2016

(54) Rendering A Media Stream By Wireless Devices Sharing Device Identifiers And Encryption Keys

(71) Applicant: Qualcomm Incorporated, San Diego, CA (US)

(72) Inventor: Brian Frederick MILLER, San Diego, CA (US)

(21) Appl. No.: 14/514,735

(22) Filed: Oct. 15, 2014

(51) Int. Cl. H04W 4/00; H04W 12/04

(52) U.S. Cl. CPC H04W 4/008; H04W 12/04

(57) ABSTRACT

Embodiments include systems and methods of enabling short-range communication among wireless devices. A passive sink device may receive an encryption key and wireless device addresses from an active sink device that has established a communication link with a source device. The passive sink device may use the encryption key and wireless device addresses to receive a media stream transmitted from the source device to the active sink device. The passive sink device may send to the active sink device information to cause the active sink device to instruct the source device to take an action to improve reception of the media stream by the passive sink device. In some embodiments, the processor of the passive sink device may send to the active sink device information about the media stream to cause the active sink device to instruct the source device to retransmit a portion of the media stream.

### BACKGROUND

Wireless devices that communicate using short range communication are increasingly ubiquitous. However, the complexity of configuring wireless devices to intercommunicate may prove both technically challenging and inconvenient for users. One of the most difficult problems that users face when configuring wireless devices to communicate with each other is the “pairing” process. Users may have trouble putting wireless devices into the correct mode for pairing, and once in the correct mode wireless devices may not readily identify another wireless device for pairing. Further, for security purposes, a user may be required to enter a code, such as a randomly generated number, personal identification number (PIN), or other code, before two wireless devices may pair and begin communication, which may require not only additional steps for the user, but also that the wireless devices include a display and a user interface.

Systems are emerging that include two or more wireless devices, such as wireless left and right earpiece devices, which are intended to be used together, e.g., to listen to music from a source device. Using such systems may be burdensome because each wireless device must be separately paired to the source device. Further, each wireless device may be presented at the source device as a separate wireless device, requiring the user to select one or both devices for different applications, such as listening to stereo music, a mono voice call, streaming mono music or other media, or other audio streams.

### SUMMARY

The various embodiments include methods of enabling short-range communications among wireless devices, which may be implemented in a wireless communication device, and which may include receiving by a passive sink device an encryption key, an active sink device address, and a source device address from an active sink device that has negotiated a communication link with a source device, using the received encryption key and wireless device addresses to receive at the passive sink device a media stream transmitted from the source device to the active sink device, and sending information about the media stream from the passive sink device to the active sink device, wherein the information may be configured to cause the active sink device to instruct the source device to take an action to improve reception of the media stream by the passive sink device.

In an embodiment, the information sent from the passive sink device to the active sink device may include information configured to cause the active sink device to instruct the source device to increase its transmit power. In an embodiment, the information sent from the passive sink device to the active sink device may include information configured to cause the active sink device to instruct the source device to transmit smaller packet sizes. In an embodiment, the information sent from the passive sink device to the active sink device may include information configured to cause the active sink device to instruct the source device to transmit the media stream using a more robust modulation scheme.

In an embodiment, using the received encryption key and wireless device addresses to receive at the passive sink device communications from the source device may include rendering the media stream from the source device at the passive sink device for presentation. In an embodiment, using the received encryption key and wireless device addresses to receive at the passive sink device a media stream transmitted from the source device to the active sink device may include passively receiving the media stream at the passive sink device. An embodiment may further include synchronizing, between the passive and active sink devices, rendering of the media stream from the source device on each of the passive and active sink devices. In an embodiment, the media stream from the source device may include a Bluetooth media stream, and the method may include the passive sink device receiving the Bluetooth media stream from the source device using the encryption key and the wireless device addresses from the active sink device, and rendering the received Bluetooth media stream for presentation.

In an embodiment, sending information about the media stream from the passive sink device to the active sink device may include sending an indication that a signal level of the media stream received from the source device by the passive sink device is below a signal level threshold. In an embodiment, sending information about the media stream from the passive sink device to the active sink device may include sending an instruction that instructs the active sink device to send a message to the source device to increase its transmit power when a signal level of the media stream from the source device received by the passive sink device is below a threshold signal level.

Various embodiments may further include methods of enabling short-range communications among wireless devices, which may be implemented in a wireless communication device, and which may include receiving by a passive sink device an encryption key, an active sink device address, and a source device address from an active sink device that has negotiated a communication link with a source device, using the received encryption key and wireless device addresses to receive at the passive sink device a media stream transmitted from the source device to the active sink device, and transmitting a signal by the passive sink device configured to cause the source device to retransmit a portion of the media stream.

In an embodiment, the communication link negotiated between the active sink device and the source device may include an encrypted communication link. In an embodiment, using the received encryption key and wireless device addresses to receive at the passive sink device a media stream transmitted from the source device to the active sink device may include passively receiving the media stream at the passive sink device. An embodiment may further include synchronizing, between the passive and active sink devices, rendering of the media stream from the source device on each of the passive and active sink devices. In an embodiment, the media stream from the source device may include a Bluetooth media stream, and the method may further include the passive sink device receiving the Bluetooth media stream from the source device using the encryption key and the wireless device addresses from the active sink device, and rendering the received Bluetooth media stream for presentation.

In an embodiment, transmitting by the passive sink device a signal configured to cause the source device to retransmit a portion of the media stream may include transmitting a pattern by the passive sink device configured to corrupt an ACK pattern transmitted by the active sink device. In an embodiment, transmitting a signal by the passive sink device configured to cause the source device to retransmit a portion of the media stream may include sending information about the media stream from the passive sink device to the active sink device in which the information is configured to cause the active sink device to instruct the source device to retransmit a portion of the media stream. In an embodiment, sending information about the media stream from the passive sink device to the active sink device may include sending an indication that the passive sink device is not receiving at least a threshold portion of the media stream.

In an embodiment, sending information about the media stream from the passive sink device to the active sink device may include sending an instruction configured to cause the active sink device to send a message to the source device to retransmit a portion of the media stream when a portion of the media stream received from the source device by the passive sink device is below a threshold level of portions of the media stream. In an embodiment, the instruction may be configured to cause the active sink device to transmit a NACK message to the source device regardless of whether the active sink device received the portion of the media stream. In an embodiment, sending information about the media stream from the passive sink device to the active device may include sending a NACK message to the active sink device.

Further embodiments include a wireless device including a processor configured with processor-executable instructions to perform operations of the embodiment methods described above.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a system diagram illustrating components suitable for use in various embodiments.

FIG. 2 is a process flow diagram illustrating an embodiment method for enabling short-range communication among wireless devices.

FIG. 3 is a call flow diagram illustrating another embodiment method for enabling short-range communication among wireless devices.

FIG. 4 is a process flow diagram illustrating another embodiment method for enabling short-range communication among wireless devices.

FIG. 5 is a call flow diagram illustrating another embodiment method for enabling short-range communication among wireless devices.

FIG. 6A and FIG. 6B are process flow diagrams illustrating alternative embodiment methods for enabling short-range communication among wireless devices.

FIG. 7 is a call flow diagram illustrating another embodiment method for enabling short-range communication among wireless devices.

FIG. 8 is a component block diagram of a mobile wireless device suitable for use in various embodiments.

FIG. 9 is a component block diagram of another mobile wireless device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide methods, and wireless devices configured to implement the methods, that enable one wireless device to share its link key of a link to a source device with another wireless device so that it can passively receive a data stream. For example, one Bluetooth device with a Bluetooth communication session established with a source wireless device to receive a media stream may share its link address and link key with a second Bluetooth device to enable that device to also receive the media stream. Embodiment methods also include mechanisms by which the passively monitoring wireless device can influence transmissions from the source device even though it is not directly linked to the source device.

Many protocols used to send voice or audio data between wireless devices assume a point-to-point wireless connection between the two devices, such as a source device (e.g., a media player) and a player or sink device (e.g., headphones). In order to enable multiple wireless sink devices to participate in the voice or audio experience (for example, separate left and right wireless speakers both playing a stereo data stream provided from a wireless media playback device), wireless sink devices all share a common device identifier and decryption key, allowing them to receive and decrypt the data transmitted by the source device. Only one of the wireless sink devices may transmit back to the source device, while the other wireless sink devices may only receive data from the source device and cannot transmit back to the source device (i.e., may passively receive data from the source device). Further, wireless communication links may be established between the multiple sink devices over which they may share device identification information, decryption key information, state information, audio synchronization information, and reception quality information.

The terms “computer,” and “computing device” are used interchangeably herein to refer to any programmable computer, server or processor that can be configured with programmable instruction to perform the embodiment methods.

The terms “wireless device” and “wireless communication device” are used herein to refer generally to any one or all of wireless accessory devices, wireless peripheral devices, cellular telephones, smartphones, web-pads, tablet computers, Internet enabled cellular telephones, WiFi enabled electronic devices, personal data assistants (PDAs), laptop computers, personal computers, and similar electronic devices equipped with a short-range radio (e.g., a Bluetooth® radio, a Peanut® radio, a WiFi radio, etc.) and/or a wide area network connection (e.g., an LTE, 3G or 4G wireless wide area network transceiver or a wired connection to the Internet). Reference to a particular type of computing device as being a mobile device or a wireless device is not intended to limit the scope of the claims unless a particular type of mobile device or wireless device is recited in the claims.

“Pairing” refers to a process in which two wireless devices that are capable of short-range wireless communication may establish a communication session with each other. Certain communication protocols, such as Bluetooth, may include a security process such as the generation of an encryption key (e.g., a link key) that is used by each of the paired wireless devices for their wireless communication. The pairing process typically is a multistep process that requires user interaction. For example, a user may be required to provide an input to each of the wireless devices to place them in a discoverable mode, a further input to at least one wireless device to select the other wireless device for pairing, and the user may further be required to enter a code or verification number to each wireless device or provide some other verification input to each wireless device (such as additional button presses). Requiring user verification in the pairing process may be used to prevent an unauthorized third wireless device from surreptitiously pairing with one of the wireless devices (e.g., to avoid a man-in-the middle attack). While wireless devices may be paired at a place of manufacture before sale to a user, doing so may make the replacement of a defective wireless device more cumbersome.

As the market for wearable wireless devices and the “Internet of Things” evolves, the complexity of the pairing process may increase as more machine-to-machine connections are desired between wireless devices that are too small for a user interface or for which the user interface design takes a backseat to the wireless device's primary purpose. Examples may include pairs of Bluetooth earpieces and speakers that can play stereo music that originates from a single source. Such products may include a left wireless device and a right wireless device that may communicate via a short range communication protocol, such as Bluetooth, in order to produce stereo music that is streamed from a third wireless device that functions as a source device, such as a media player, a smart phone, or another media source. Using such systems may be burdensome because each wireless device must be separately paired to the source device. Further, each wireless device may be presented to a user at the source device as a separate wireless device, requiring the user to select one or both devices for different applications, such as listening to stereo music, receiving a mono voice call, streaming mono music or other media, or another use.

The various embodiments include methods, and wireless devices configured to implement the methods, of passive reception by a first wireless device (referred to herein as a passive sink device) of a media stream transmitting over a short-range communication link established between a second wireless device (referred to herein as an active sink device) and third wireless device (referred to herein as a source device). In a particular embodiment, the communication link may be a Bluetooth connection. In some embodiments, the active sink device and the source device may negotiate a communication link. In some embodiments, the short range communication link may be encrypted (e.g., in a Bluetooth link), and as part of the negotiation process the active sink device and the source device may determine an encryption key or other data to enable each device to encode and decode communications over the communication link. In addition, the active sink device may provide to the source device, or the source device may assign to the active sink device, an address to which communications will be sent by the source device, such as a Bluetooth device address or another similar device address. Further, the source device may provide to the active sink device a device address of the source device. In the various embodiments, the active sink device may provide the encryption key, the active sink device address, and the source device address to the passive sink device. The passive sink device may store the encryption key and the wireless device addresses. Subsequently, when communications are sent from the source device to the active sink device, the passive sink device may passively receive and decode the communications using the stored encryption key, the shared wireless device address, and the source device address.

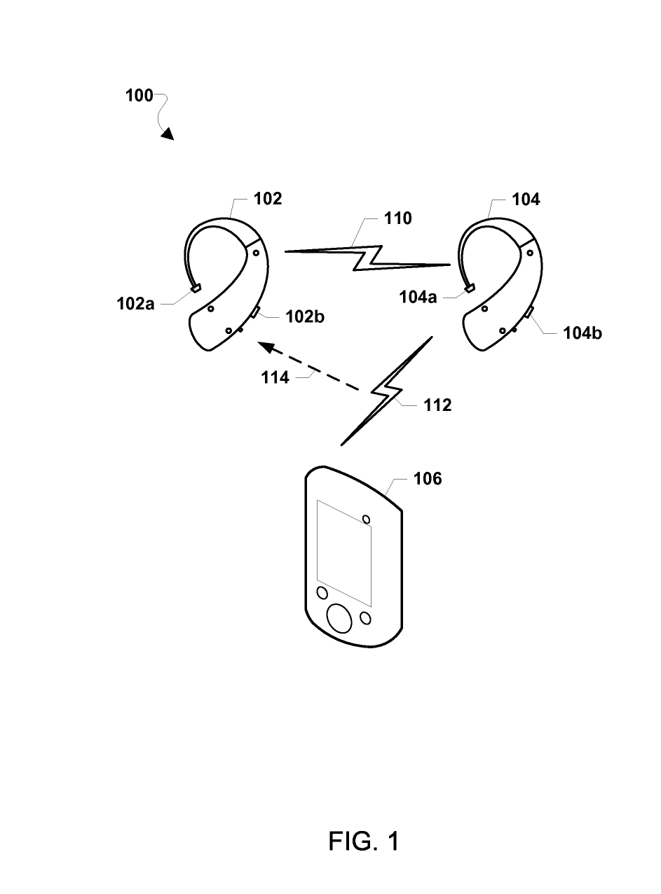

FIG. 1 illustrates a system 100 suitable for use in various embodiments including a passive sink device 102, an active sink device 104, and a source device 106. Each of the passive and active sink devices may be configured to wirelessly exchange information 110 to exchange control information, synchronization information, and other information that may be sent between the passive and active sink devices. In some embodiments, the passive sink device and the active sink device may communicate using serial port profile (SPP) or another similar profile or communication protocol.

Each of the passive sink device, the active sink device, and the source device may include a memory or similar non-transitory computer-readable or processor-readable media, and a processor for executing code and/or instructions that may be stored in the memory. Each of the passive and active sink devices may also include an audio output 102a, 104a, such as a speaker, for generating sound in response to audio signals, and an input device 102b, 104b, such as a button, slider, knob, or similar physical input device. The passive and active sink devices may be relatively small such that they may be worn on a user's body (e.g., as earpieces) or attached to the outside of a user's clothing.

The source device 106 may include a function, such as a media player, that transmits audio and/or other media to the active sink device 104 via communication link 112. The active sink device and the source device may perform a pairing process between them to establish the communication link 112.

In some embodiments, the communication link 112 may be encrypted, and as part of the pairing process the active sink device and the source device may determine an encryption key (e.g., a link key) to enable each device to encode and decode communications over the communication link 112. In addition, the active sink device may provide to the source device an address to which communications will be sent by the source device, such as a Bluetooth device address or another similar device address. Further, the source device may provide a device address (e.g., a Bluetooth device address or the like) to the active sink device. In some embodiments, the active sink device and the source wireless device may communicate using an advanced audio distribution profile (A2DP) configuration, a hands-free profile (HFP), or another similar profile, or communication protocol.

When the active sink device and the source device have completed the pairing process, the active sink device 104 may provide the encryption key, the active sink device address, and the source device address to the passive sink device 102, and the passive sink device may store the encryption key and the addresses of the active sink device and the source device. When communications, such as a media stream, are sent from the source device to the active sink device using the stored encryption key and the active sink device address, the passive sink device may passively receive 114 and decode the communications using the stored encryption key, the active sink device address and the source device address. In some embodiments, the media stream may include a Bluetooth media stream.

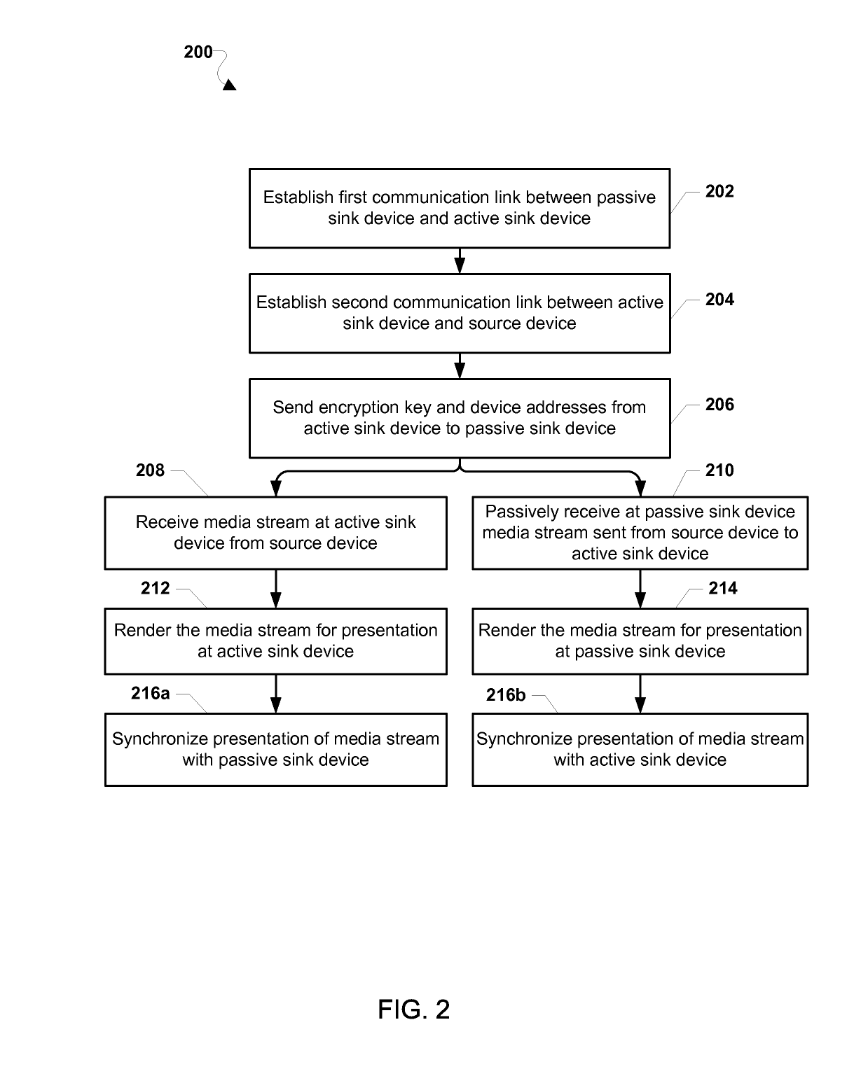

FIG. 2 is a process flow diagram illustrating an embodiment method 200 for enabling short-range communication among wireless devices. In block 202, a passive sink device (e.g., passive sink device 102) and an active sink device (e.g., active sink device 104) may establish (e.g., negotiate) a first communication link between them. The first communication link may use a short-range communication protocol, such as Bluetooth. Establishing the first communication link may include a pairing process, such as a Bluetooth pairing process.

In block 204, the active sink device and the source device (e.g., source device 106) may establish (e.g., negotiate) a second communication link between them. Establishing the second communication link may include a pairing process between the active sink device and the source device. The second communication link may also use a short-range communication protocol, such as Bluetooth.

In block 206, the active sink device may send to the passive sink device an encryption key (e.g., an encryption key resulting from a negotiation of the second communication link in block 204), the active sink device address, and the source device address. The passive sink device may store the encryption key and the device addresses in a memory of the passive sink device. In some embodiments, the active sink device may provide its device address to the passive sink device when the first communication link is established in block 202. In such case, the active sink device may provide the source device address and the encryption key to the passive sink device in block 206.

The source device may transmit a media stream to the active sink device, which the active sink device may, in block 208, receive over the second communication link. In block 210, the passive sink device may use the stored wireless device addresses of the active sink device and the source device and the encryption key to passively receive the media stream and/or other communications transmitted from the source device to the active sink device over the communication link 112. Passive reception refers to receiving communications by the passive sink device without acknowledging the reception to the transmitting device. For example, when the active sink device receives the communications transmitted from the source device, the active sink device may transmit a message or messages to the source device indicating that the active sink device has received the communications (e.g., an ACK message or another acknowledgement message). This may be referred to as active reception by the active sink device. In contrast, the passive sink device may receive the communications sent from the source device using the stored wireless device addresses and the encryption key, but the passive sink device may not send an acknowledgement message to the source device (e.g., an ACK message). In some embodiments, the passive sink device may not send any message to the source device indicating that it has not received the media stream (e.g., a NACK message). This may be referred to as passive reception by the passive sink device. In some embodiments, the passive reception by the passive sink device and the active reception by the active sink device may occur substantially simultaneously.

In block 212, a processor of the active sink device may render the media stream for presentation, and in block 214, a processor of the passive sink device may render the media stream for presentation. Rendering the media stream for presentation may include decrypting encrypted information in the media stream using the encryption key stored on the respective passive and active sink devices, processing the decrypted information, and presenting at least a portion of the decrypted information, e.g., playing at least a portion of the media stream (such as a left channel, a right channel, or both in a stereo audio stream), displaying at least a portion of the media stream, or otherwise presenting at least a portion of the decrypted information.

In blocks 216a and 216b, respective processors of the passive and active sink devices may exchange information over the first communication link to synchronize the presentation of the media stream. For example, when playing back a stereo audio stream, the audio must be presented by both the passive and active sink devices within a relatively short period (approximately 20 μs) in order to sound to a user that the presentation by the passive and active sink devices is substantially simultaneous. (A relative playback difference of greater than approximately 20 μs may be perceptible to a user.) The passive and active sink devices may exchange information over the first communication link to synchronize the presentation of the media stream such that the media stream is presented by the passive and active sink devices within the relatively short period. As one example, frames may be synchronized between the passive and active sink devices by comparing hash values calculated from frames of an audio stream with one or a sequence of hashes provided to a receiving wireless device by a source device in a separate control stream, and determining when to begin processing received data frames based upon when the first and second sequences of hash values match, as described in U.S. Published Patent Application 2014/0029701, which is incorporated herein by reference in its entirety.

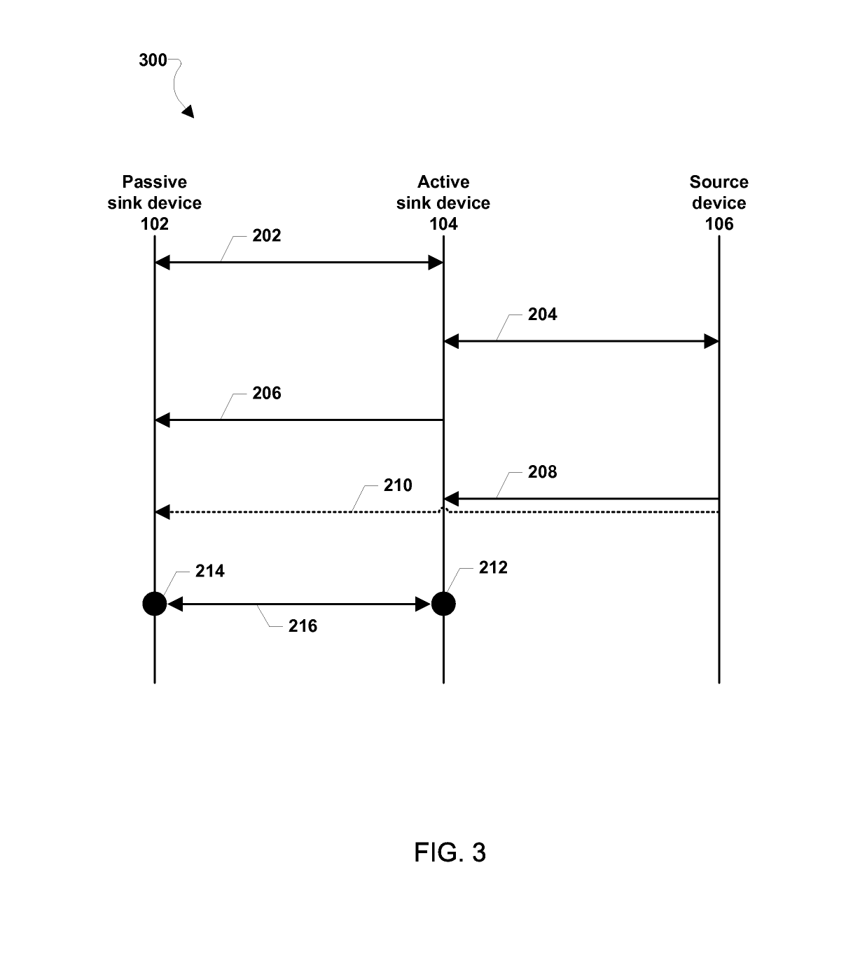

FIG. 3 is a call flow diagram illustrating another embodiment method 300 for enabling short-range communication among wireless devices. The passive sink device 102 and the active sink device 104 may establish a first communication link between them 202, using a short-range communication protocol, such as Bluetooth. Establishing the first communication link may include a pairing process, such as a Bluetooth pairing process.

The active sink device 104 and the source device 106 may establish a second communication link between them 204. Establishing the second communication link may include a pairing process between the active sink device and the source device, and may use a short-range prediction protocol, such as Bluetooth. The active sink device may send to the passive sink device addresses of the active sink device and the source device and an encryption key resulting from the establishment of the second communication link 206. The passive sink device may store the encryption key and the device addresses of the active sink device and the source device in a memory of the passive sink device.

The source device may transmit a media stream 208 to the active sink device, which the active sink device may receive over the second communication link. The passive sink device may use the stored wireless device addresses of the active sink device and the source device and the encryption key to passively receive the media stream 210 transmitted from the source device to the active sink device over the second communication link. The active sink device may render the media stream for presentation 212. The passive sink device may also render the media stream for presentation 214. The active and passive sink devices may exchange information over the first communication link to synchronize the presentation of the media stream 216.

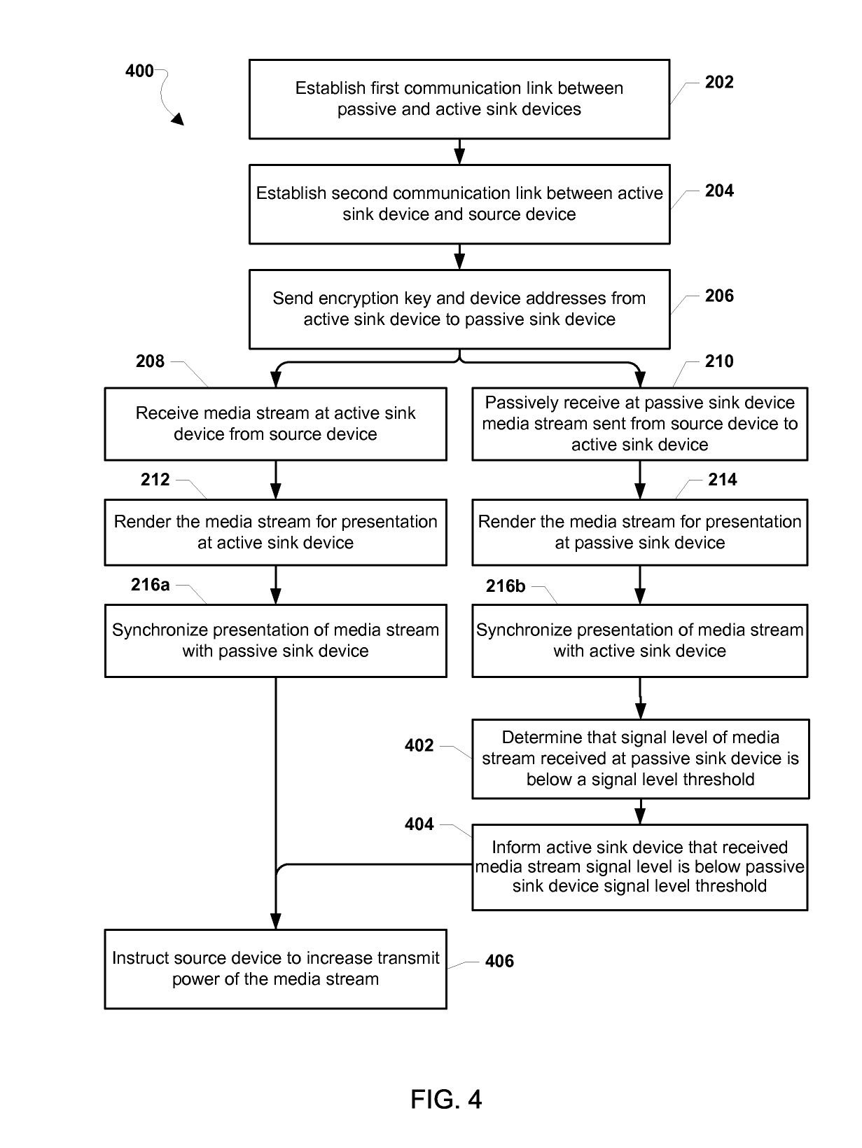

FIG. 4 is a process flow diagram illustrating another embodiment method 400 for enabling short-range communication among wireless devices. In block 202, the passive sink device (e.g., the passive sink device 102) and the active sink device (e.g., the active sink device 104) may establish a first communication link between them. In block 204, the active sink device and the source device (e.g., the source device 106) may establish a second communication link between them. Establishing the first and second communication links may include a pairing process between the respective wireless devices, and may use a short-range prediction protocol, such as Bluetooth.

In block 206, the active sink device may send to the passive sink device an encryption key (e.g., an encryption key resulting from a negotiation of the second communication link in block 204), the active sink device address, and the source device address, and the passive sink device may store the encryption key and the device addresses in a memory of the passive sink device. The source device may transmit a media stream to the active sink device, which the active sink device may, in block 208, receive over the second communication link. In block 210, a processor of the passive sink device may use the stored wireless device addresses and the encryption key to passively receive the media stream and/or other communications transmitted from the source device to the active sink device over the second communication link. In block 212, a processor of the active sink device may render the media stream for presentation, and in block 214, the passive sink device may render the media stream for presentation. In blocks 216a and 216b, processors of the active and passive sink devices may exchange information over the first communication link to synchronize the presentation of the media stream.

In block 402, the passive sink device and/or the active sink device may determine that a signal level of the media stream that the passive sink device passively receives is below a signal level threshold. In some embodiments, a processor of the passive sink device may determine that the signal level of the media stream is below the signal level threshold, and the processor of the passive sink device may send the determination to the active sink device. In some embodiments, the passive sink device may provide a received signal level to the active sink device (e.g., over the first communication link), and a processor of the active sink device may determine that the signal level of the media stream passively received by the passive sink device is below the signal level threshold. In some embodiments, the active sink device may detect an audio output from the passive sink device (e.g., from the speaker 102a of the passive sink device 102), and a processor of the active sink device may determine based on the detected audio output that the signal level of the media stream that the passive sink device is passively receiving is below the signal level threshold (e.g., by determining that a signal quality of the audio output is below an audio output quality threshold). The signal level threshold may include a signal level sufficient for the passive sink device to passively receive the media stream and render it for presentation to meet a threshold level of playback performance or rendering quality. In block 404, regardless of whether the active or passive sink device makes the determination, the active sink device is informed that the signal level of the passively received media stream is below the signal level threshold. Informing the active sink device may include sending a determination from the passive sink device to the active sink device, and making the determination at the active sink device.

In block 406, the active sink device may instruct the source device to increase a transmit power of the media stream. In some embodiments, the active sink device may instruct the source device to transmit the media stream at a substantially maximum transmit power. Because the passive sink device passively receives the media stream, the passive sink device may not send to the source device any indication that the signal level may be below the threshold signal level (such as a non-acknowledgment message, e.g., a NACK message, or another indication of receipt failure). Instructing the source device to increase (or maximize) its transmit power may increase the likelihood that the passive sink device may reliably receive the media stream.

Because instructing the source device to increase (or maximize) its transmit power may increase the likelihood that the passive sink device may reliably receive the media stream, in some embodiments, the active sink device may be configured to instruct the source device to increase its transmit power of the media stream without receiving any feedback or instructions from the passive sink device. For example, in response to establishing the first communication link between the passive and active sink devices and/or in response to sending the encryption key and/or the source and active sink device addresses to the passive sink device, the active sink device may instruct the source device to increase its transmit power of the media stream without receiving any feedback or instructions from the passive sink device (i.e., regardless of whether the passive sink device informs the active sink device that the media stream signal level is below the signal level threshold).

In some embodiments, in response to determining that the signal level is below the signal level threshold, the active sink device may send the instruction to the source device to increase or maximize its transmit power and to override a transmit power optimization process between the active sink and source devices. For example, actively communicating wireless devices (e.g., the active sink and source devices) may perform a transmit power optimization process in which the active sink device may send to the source device instructions to increase or decrease its transmit power, to set the transmit power of the source device high enough that the active sink device may reliably receive a media stream from the source device, and at a transmit power that is lower than a maximum power, to conserve power and/or avoid wasting power at the source device. Such a transmit power optimization process may use control information exchanged between the active sink device and the source device to tune the source device's transmit power. However, the passively receiving passive sink device may provide no feedback information to the source device, and the transmit power optimization process between the active sink and source devices may set the transmit power level too low for the passive sink device to reliably receive the media stream. Thus, in some embodiments, the instruction sent to the source device to increase or maximize its transmit power in response to determining that the signal level is below the signal level threshold may override a transmit power optimization process between the active sink and source devices. Increasing or maximizing the source device's transmit power level may increase the likelihood that the passive sink device may accurately receive the media stream.

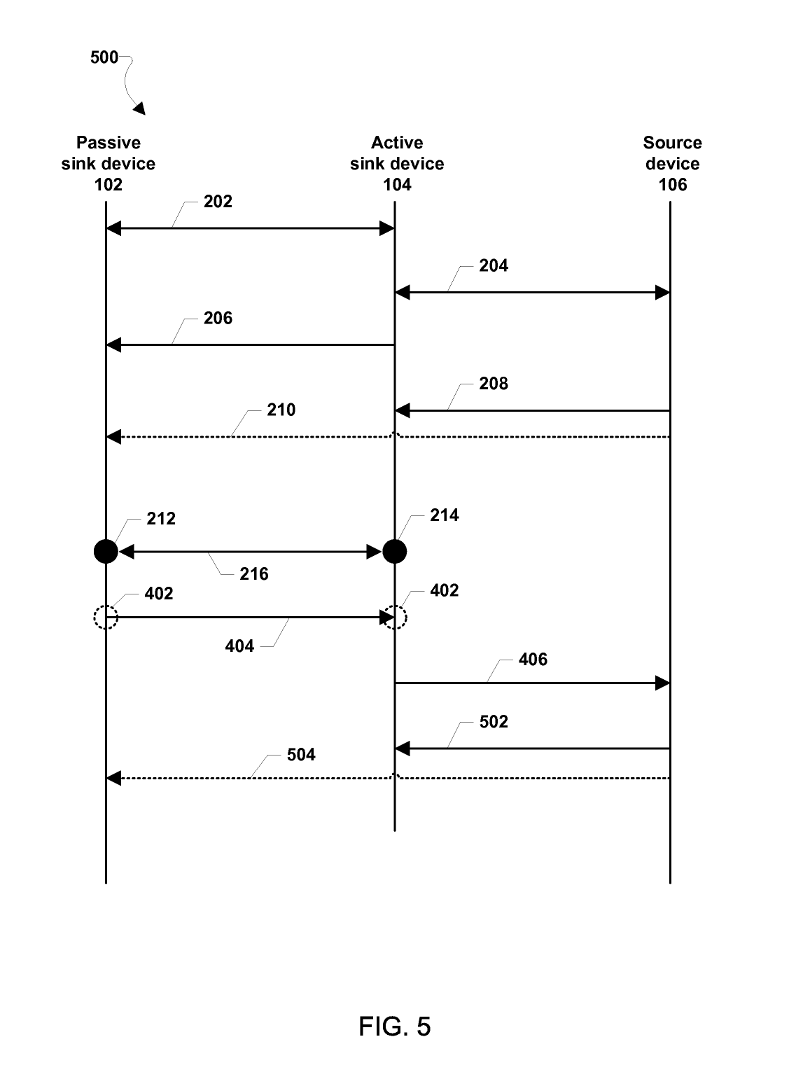

FIG. 5 is a call flow diagram illustrating another embodiment method 500 for enabling short-range communication among wireless devices. The passive sink device 102 and the active sink device 104 may establish a first communication link between them 202, using a short-range communication protocol, such as Bluetooth. Establishing the first communication link may include a pairing process, such as a Bluetooth pairing process.

The active sink device 104 and the source device 106 may establish a second communication link between them 204. Establishing the second communication link may include a pairing process between the active sink device and the source device, and may use a short-range prediction protocol, such as Bluetooth. The active sink device may send to the passive sink device an active sink device address, a source device address, and an encryption key resulting from the establishment of the second communication link 206. The passive sink device may store the encryption key and the device addresses in a memory of the passive sink device.

The source device may transmit a media stream 208 to the active sink device, which the active sink device may receive over the second communication link. The passive sink device may use the stored wireless device addresses and the encryption key to passively receive the media stream 210 transmitted from the source device to the active sink device over the second communication link. The active sink device may render the media stream for presentation 212. The passive sink device may also render the media stream for presentation 214. The active and passive sink devices may exchange information over the first communication link to synchronize the presentation of the media stream 216.

The passive sink device and/or the active sink device may determine that a signal level of the media stream that the passive sink device passively receives is below a signal level threshold 402. Regardless of whether the active or passive sink device makes the determination, the active sink device is informed that the signal level of the passively received media stream is below the signal level threshold 404. In some embodiments, a processor of the passive sink device may determine that the signal level of the media stream that it is passively receiving is below the signal level threshold, and the processor of the passive sink device may send the determination to the active sink device. In some embodiments, the passive sink device may provide a received signal level to the active sink device (e.g., over the first communication link), and a processor of the active sink device may determine that the signal level of the media stream that the passive sink device is passively receiving is below the signal level threshold.

The active sink device may instruct the source device to increase a transmit power of the media stream 406. In some embodiments, the active sink device may instruct the source device to transmit the media stream at a substantially maximum transmit power.

The source device may adjust its transmit power level and may transmit a media stream to the active sink device using the adjusted transmit power level 502, which the active sink device may receive over the second communication link. The passive sink device may use the stored wireless device addresses and the encryption key to passively receive the media stream 504 transmitted from the source device to the active sink device over the second communication link using the adjusted transmit power level.

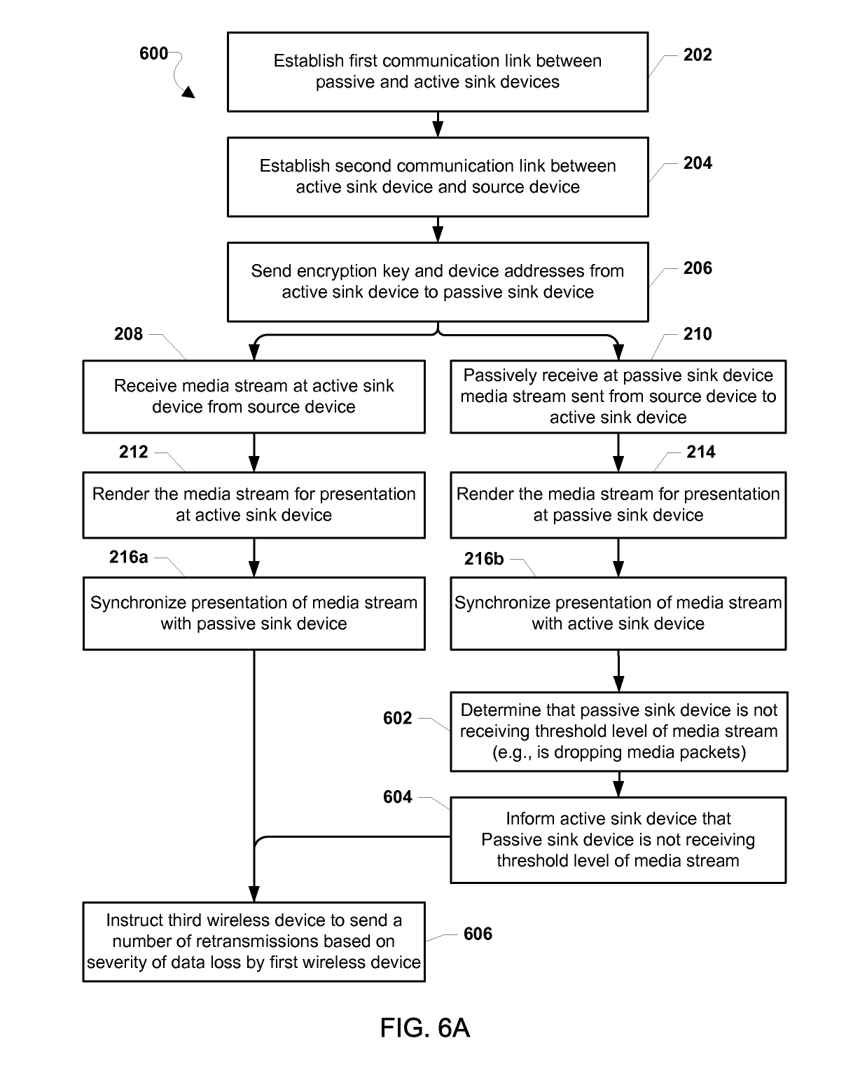

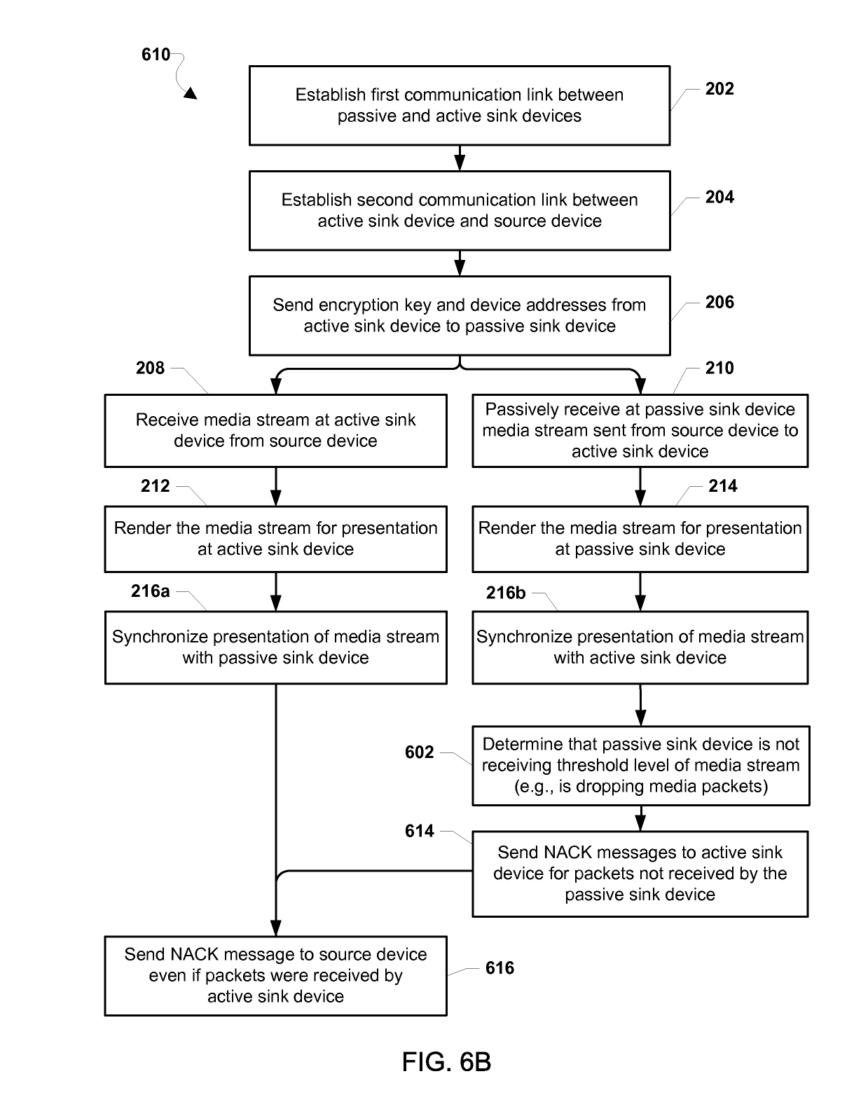

FIG. 6A is a process flow diagram illustrating another embodiment method 600 for enabling short-range communication among wireless devices. In block 202, the active and passive sink devices (e.g., active and passive sink devices 102 and 104) may establish a first communication link between them. In block 204, the active sink device and the source devices (e.g., source device 106) may establish a second communication link between them. Establishing the first and second communication links may include a pairing process between the respective wireless devices, and may use a short-range prediction protocol, such as Bluetooth.

In block 206, active sink device may send to the passive sink device the encryption key and the wireless device addresses of the active and source devices, and the passive sink device may store the encryption key and the wireless device addresses in a memory of the passive sink device. In block 208, the source device may transmit a media stream to the active sink device, which the active sink device may receive over the second communication link. In block 210, the passive sink device may use the stored wireless device addresses and the encryption key to passively receive the communications transmitted from the source device to the active sink device over the second communication link. In block 212, the active sink device may render the media stream for presentation, and in block 214, the passive sink device may render the media stream for presentation. In blocks 216a and 216b, the passive and active wireless devices may exchange information over the first communication link to synchronize the presentation of the media stream.

In block 602, the passive sink device and/or the active sink device may determine that the passive sink device is not reliably receiving the media stream, for example, may determine that the passive sink device is not receiving a threshold level of the media stream. In some embodiments, a processor of the passive sink device may determine that it is not passively receiving at least a threshold portion of the media stream. The threshold portion of the media stream may include a threshold level of datagrams or packets of the media stream. The determination may include determining that an error rate meets a threshold error rate, determining that a rate of packet loss meets a threshold packet loss rate, or another determination that the passive sink device is not receiving the media stream sufficient to provide a threshold level of rendering and presentation of the media stream. In some embodiments, the passive sink device may provide an error rate, an indication of unreceived data (e.g., dropped packets) of the media stream, or another indication that the passive sink device is not receiving the media stream sufficient to provide a threshold level of rendering and presentation of the media stream, and a processor of the active sink device may determine that the passive sink device is not receiving the media stream sufficient to provide a threshold level of rendering and presentation of the media stream.

In block 604, regardless of whether the passive or active sink device makes the determination, the active sink device is informed that the passive sink device is not receiving a threshold level of the media stream, for instance, that the signal level of the passively received media stream is not sufficient for the passive sink device to provide a threshold level of rendering and presentation of the media stream. In some embodiments, a processor of the passive sink device may determine that the passive sink device is not receiving the media stream sufficient to provide a threshold level of presentation, and the processor of the passive sink device may send the determination to the active sink device. In some embodiments, the passive sink device may provide the indication that the passive sink device is not receiving the media stream sufficient to provide a threshold level of presentation to the active sink device (e.g., over the first communication link), and a processor of the active sink device may determine that the passive sink device is not receiving the media stream sufficient to provide the threshold level of presentation of the media stream.

In block 606, the active sink device may instruct the source device to retransmit one or more packets or datagrams of the media stream. In some embodiments, the instruction sent by the active sink device to the source device to retransmit packets of the media stream may include a non-acknowledgement message. In some embodiments, the active sink device may request a number of retransmissions that is based on the severity of the data loss reported by the passive sink device (e.g., as a number of packets dropped, an error rate, or another error metric increases).

In some embodiments the active sink device may instruct the source device to retransmit packets or datagrams on behalf of the passive sink device by sending NACK messages even when the active sink device successfully received those packets or datagrams. This is illustrated in FIG. 6B. The method 610 illustrated in FIG. 6B is similar to the method 600 described above with reference to FIG. 6A for like numbered blocks with the addition of block 616 in which the active sink device transmits NACK messages to the source device in response to receiving signals from the passive sink device, even if the active sink device did receive the corresponding packet or datagrams. Thus, if the active sink device is informed that the passive sink device missed a packet, the active sink device may send a NACK message instead of the ACK message it would have sent upon receiving the packet. Also, if the active sink device is informed that the passive sink device missed a packet and the active sink device also did not receive the packet, the active sink device may sent two NACK messages (i.e., send a second NACK message upon receiving the packet on the second transmission). The passive and/or active sink device may determine a number of non-acknowledgement messages to send to the source device based on the severity of the data loss by the passive sink device.

In an embodiment also illustrated in FIG. 6B, the passive sink device may inform the active sink device that the passive sink device has missed packets by sending NACK messages for the missed packets 614. The NACK message may include a standard format that the devices are configured to send and receive, and thus provides a convenient mechanism for the passive sink device to inform the active sink device of the packet or packets that have been missed. In an embodiment, the active sink device may be configured to effectively forward the NACK message received from the passive sink device on to the source device with little delay or processing.

In some embodiments, the active sink device may send at least one non-acknowledgement (NACK) message even when the active sink device receives the portion of the media stream for which retransmission is requested and without a packet-by-packet prompting by the passive sink device. For example, in response to receiving a message from the passive sink device that it is not receiving the threshold level of media stream packets (e.g., the passive sink device is dropping a threshold number of packets, or the error rate meets a threshold error rate), the active sink device may begin sending at least one NACK message for each packet causing the source device to retransmit all packets even when the active sink device has received them. Sending NACK messages in response to receiving a packet may cause the source device to send packets twice (or more times), thereby improving the chances that the passive sink device receives the packets.

In some embodiments, instead of transmitting a NACK message from the active sink device, the passive sink device may transmit a pattern or a signal that may disrupt or effectively corrupt an acknowledgement message (i.e., ACK) sent by the active sink device. For example, in response to determining that the passive sink device is not receiving the threshold level of the media stream (i.e., is dropping packets), the passive sink device may transmit a signal or pattern to disrupt, corrupt, or overwhelm an ACK message sent by the active sink device. The source device may interpret the disrupted/corrupted ACK message as an implied NACK message, and the source device may retransmit packet(s) in response to the implied NACK message.

Because the passive sink device passively receives the media stream, the passive sink device may not send to the source device any indication that the passive sink device is not receiving data of the media stream (e.g., is dropping packets) such as a non-acknowledgment message, a NACK message, or another indication of data receipt failure. Instructing the source device to retransmit data of the media stream may increase the likelihood that the passive sink device may accurately receive the media stream. In some embodiments, the active sink device may be configured to instruct the source device to increase a number of packet retransmissions without receiving any feedback or instructions from the passive sink device. For example, in response to establishing the first communication link between the passive and active sink devices and/or in response to sending the encryption key and/or the source and active sink device addresses to the passive sink device, the active sink device may instruct the source device to increase a number of packet retransmissions without receiving any feedback or instructions from the passive sink device (i.e., regardless of whether the passive sink device informs the active sink device that any packets are missed).

In some embodiments, to increase the chances that the passive sink device receives the packets from the source device, the active sink device may instruct the source device to decrease a size of each packet of the media stream that the source device transmits. For example, transmitting a greater number of smaller packets from the source device may increase the likelihood that the passive sink device may properly receive the media stream packets. In some embodiments, the active sink device may send an instruction to the source device to decrease and/or adjust the media stream packet size together with the instruction to increase a media stream transmit power (i.e., in block 406 of FIG. 4), together with the instruction to retransmit packets (i.e., in block 606 of FIG. 6A), together with a NACK sent to the source device (i.e., in block 616 of FIG. 6B), or alone, either in response to a determination that the media stream received at the passive sink device is below the threshold signal level (i.e., in block 402 of FIG. 4), or in response to a determination that the passive sink device is dropping packets (i.e., in block 602 of FIGS. 6A and 6B).

In some embodiments, to increase the chances that the passive sink device receives the packets from the source device, the active sink device may instruct the source device to adjust a modulation scheme used by the source device to transmit the media stream. For example, transmitting the media stream using a more robust modulation scheme may increase the likelihood that the passive sink device may properly receive the media stream packets. In some embodiments, the active sink device may send an instruction to the source device to adjust its modulation scheme together with the instruction to increase a media stream transmit power (i.e., in block 406 of FIG. 4), together with the instruction to retransmit packets (i.e., in block 606 of FIG. 6A), together with a NACK sent to the source device (i.e., in block 616 of FIG. 6B), or alone, either in response to a determination that the media stream received at the passive sink device is below the threshold signal level (i.e., in block 402 of FIG. 4), or in response to a determination that the passive sink device is dropping packets (i.e., in block 602 of FIGS. 6A and 6B).

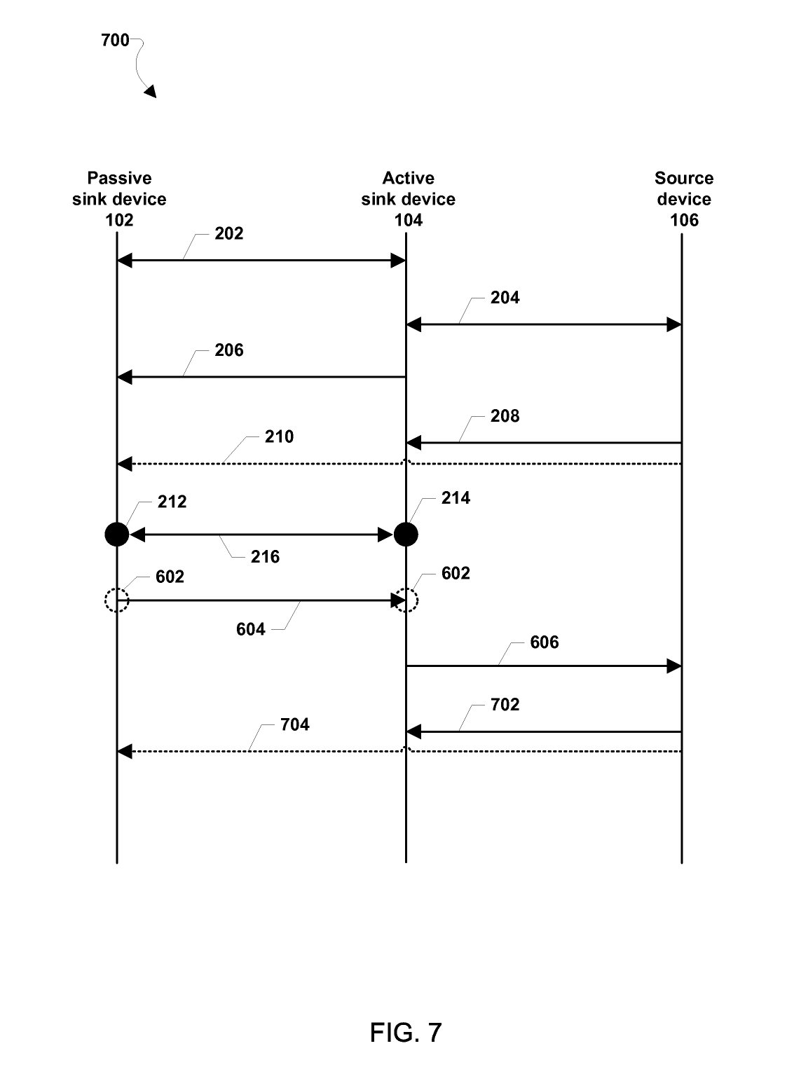

FIG. 7 is a call flow diagram illustrating another embodiment method 700 for enabling short-range communication among wireless devices. The passive sink device 102 and the active sink device 104 may establish a first communication link between them, using a short-range communication protocol, such as Bluetooth 202. Establishing the first communication link may include a pairing process, such as a Bluetooth pairing process.

The active sink device 104 and the source device 106 may establish a second communication link between them 204. Establishing the second communication link may include a pairing process between the active sink and source devices, and may use a short-range communication protocol, such as Bluetooth. The active sink device may send to the passive sink device the addresses of the active sink and source devices and an encryption key resulting from the negotiation of the second communication link 206. The passive sink device may store the encryption key and the wireless device addresses in a memory of the passive sink device.

The source device may transmit a media stream to the active sink device 208, which the active sink device may receive over the second communication link. The passive sink device may use the stored wireless device addresses and the encryption key to passively receive the media stream 210 transmitted from the source device to the active sink device over the second communication link. The active sink device may render the media stream for presentation 212, and the passive sink device may also render the media stream for presentation 214. The passive and active sink devices may exchange information 216 over the first communication link to synchronize the presentation of the media stream.

The passive sink device and/or the active sink device may determine that the passive sink device is not receiving the media stream sufficient to provide a threshold level of rendering and presentation of the media stream 602. Regardless of whether the passive or active device makes the determination, the active sink device is informed that the signal level of the passively received media stream is not sufficient for the passive sink device to provide a threshold level of rendering and presentation of the media stream 604. In some embodiments, a processor of the passive sink device may determine that the passive sink device is not receiving the media stream sufficient to provide a threshold level of presentation, and the processor of the passive sink device may send the determination to the active sink device. In some embodiments, the passive sink device may provide the indication that the passive sink device is not receiving the media stream sufficient to provide a threshold level of presentation to the active sink device (e.g., over the first communication link), and a processor of the active sink device may determine that the passive sink device is not receiving the media stream sufficient to provide the threshold level of presentation of the media stream.

The active sink device may instruct the source device to retransmit one or more packets or datagrams of the media stream 606. In some embodiments, the number of retransmissions requested by the active sink device may increase as the severity of the data loss by the passive sink device (e.g., a number of packets dropped, or an error rate) increases.

The source device may retransmit one or more packets/datagrams of the media stream 702 in response to the retransmission request(s) received over the second communication link. The passive sink device may use the stored wireless device addresses and the encryption key to passively receive the retransmitted packet(s) 704 retransmitted from the source device to the active sink device over the second communication link. In some embodiments, the active sink device may discard retransmitted packets when the active sink device has properly received the initial transmission of those packets.

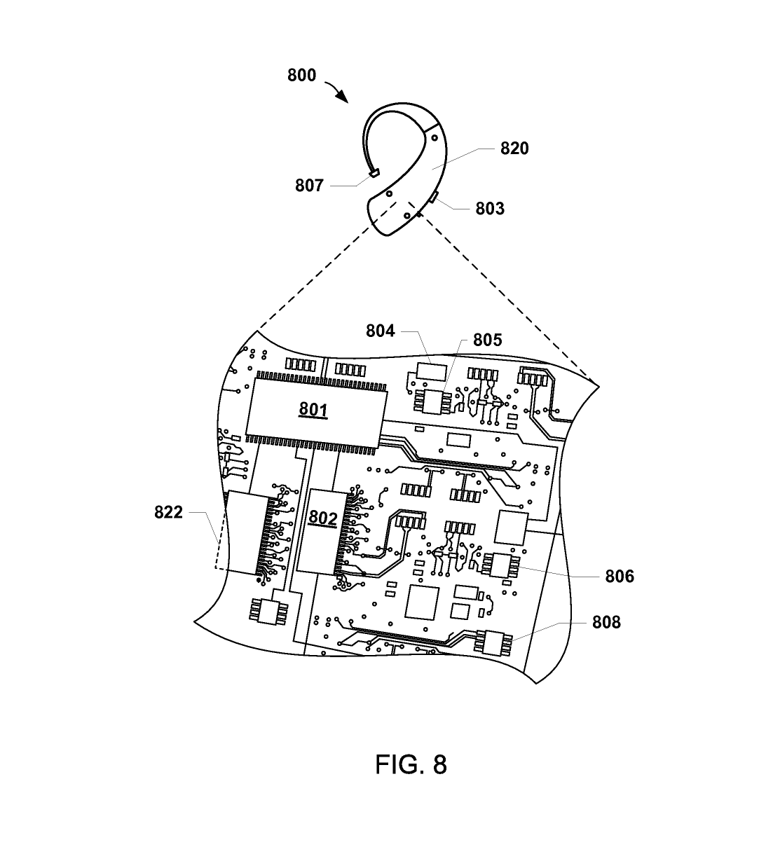

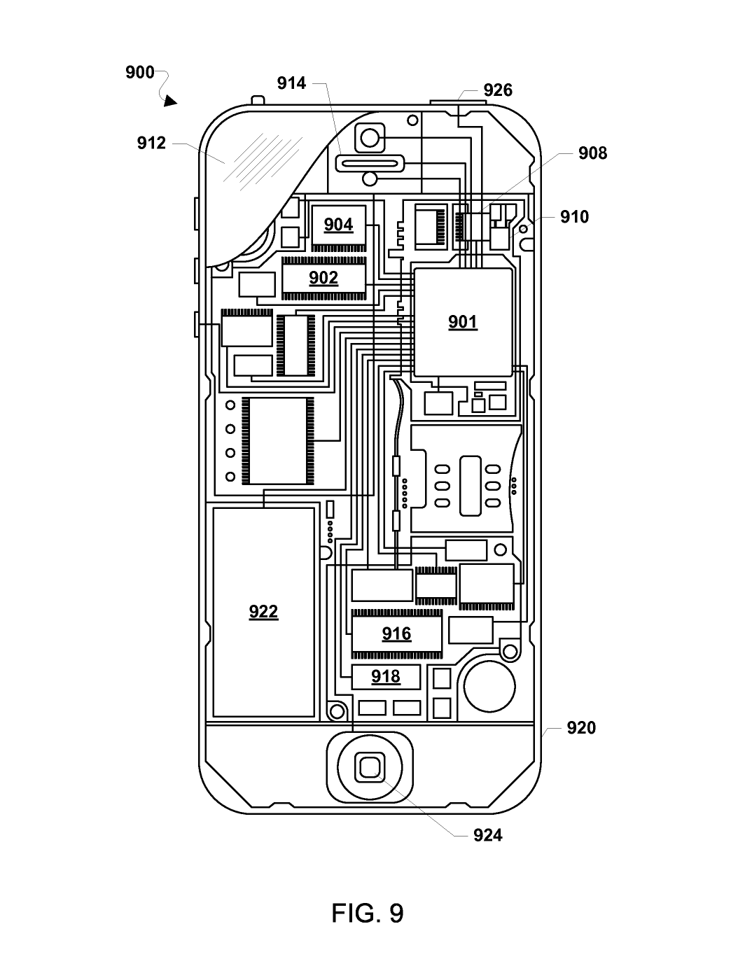

Various embodiments may be implemented in any of a variety of mobile communication wireless devices, examples of which (e.g., an earpiece 800 and a mobile wireless communication device 900) are illustrated in FIGS. 8 and 9. In various embodiments, the earpiece 800 may be similar to the passive and active sink devices 102 and 104, and the mobile communication wireless device 900 may be similar to the source device 106 as described with reference to FIG. 1. As such, the earpiece 800 and the mobile communication wireless device 900 may implement the methods 200, 300, 400, 600, 610, and 700 of FIGS. 2-7.

The earpiece 800 may include a processor 801 coupled to internal memory 802. The earpiece 800 may include an antenna 804 for sending and receiving electromagnetic radiation that may be connected to a wireless data link transceiver 805 coupled to the processor 801. The transceiver 805 may include a Bluetooth transceiver 808 for low-power short-range communications between wireless devices, or other similar communication circuitry (e.g., circuitry implementing the ZigBee (i.e., an IEEE 802.15.4) or WiFi protocols, etc.). The earpiece 800 may include a sound encoding/decoding (CODEC) circuit 806 that digitizes sound received from a microphone into data packets suitable for wireless transmission and decodes received sound data packets to generate analog signals that are provided to a speaker 807 for providing audio outputs. Also, one or more of the processor 801, wireless transceiver 805 and CODEC 806 may include a digital signal processor (DSP) circuit (not shown separately).

The earpiece 800 may also include a housing 820, constructed of a plastic, metal, or a combination of materials, for containing all or some of the components discussed herein. The earpiece 800 may include a power source 822 coupled to the processor 801, such as a disposable or rechargeable battery. The rechargeable battery may also be coupled to a peripheral wireless device connection port to receive a charging current from a source external to the earpiece 800. The earpiece 800 may also include a physical button 803 for receiving user inputs and/or for turning the earpiece 800 on and off. The earpiece 800 may also include one or more light-emitting diodes (LEDs) or other similar emitters to provide indications of power status and the like.

FIG. 9 is a component block diagram of a mobile communication wireless device 900 suitable for implementing various embodiments. The mobile communication wireless device 900 may include a processor 901 coupled to a touchscreen controller 904 and an internal memory 902. The processor 901 may be one or more multi-core integrated circuits designated for general or specific processing tasks. The internal memory 902 may be volatile or non-volatile memory, and may also be secure and/or encrypted memory, or unsecure and/or unencrypted memory, or any combination thereof. The touchscreen controller 904 and the processor 901 may also be coupled to a touchscreen panel 912, such as a resistive-sensing touchscreen, capacitive-sensing touchscreen, infrared sensing touchscreen, etc. Additionally, the display of the mobile communication wireless device 900 need not have touch screen capability.

The mobile communication wireless device 900 may have two or more radio signal transceivers 908 (e.g., Peanut, Bluetooth, Zigbee, Wi-Fi, RF radio) and antennae 910, for sending and receiving communications, coupled to each other and/or to the processor 901. The transceivers 908 and antennae 910 may be used with the above-mentioned circuitry to implement the various wireless transmission protocol stacks and interfaces. The mobile communication wireless device 900 may include one or more cellular network wireless modem chip(s) 916 coupled to the processor and antennae 910 that enable communication via two or more cellular networks via two or more radio access technologies.

The mobile communication wireless device 900 may include a peripheral wireless device connection interface 918 coupled to the processor 901. The peripheral wireless device connection interface 918 may be singularly configured to accept one type of connection, or may be configured to accept various types of physical and communication connections, common or proprietary, such as USB, FireWire, Thunderbolt, or PCIe. The peripheral wireless device connection interface 918 may also be coupled to a similarly configured peripheral wireless device connection port (not shown).

The mobile communication wireless device 900 may also include speakers 914 for providing audio outputs. The mobile communication wireless device 900 may also include a housing 920, constructed of a plastic, metal, or a combination of materials, for containing all or some of the components discussed herein. The mobile communication wireless device 900 may include a power source 922 coupled to the processor 901, such as a disposable or rechargeable battery. The rechargeable battery may also be coupled to the peripheral wireless device connection port to receive a charging current from a source external to the mobile communication wireless device 900. The mobile communication wireless device 900 may also include a physical button 924 for receiving user inputs. The mobile communication wireless device 900 may also include a power button 926 for turning the mobile communication wireless device 900 on and off.

The processors 801 and 901 may be any programmable microprocessor, microcomputer or multiple processor chip or chips that can be configured by software instructions (applications) to perform a variety of functions, including the functions of various embodiments described below. In some mobile wireless devices, multiple processors 801 and 901 may be provided, such as one processor dedicated to wireless communication functions and one processor dedicated to running other applications. Typically, software applications may be stored in the internal memory 802 and 902 before they are accessed and loaded into the processor 801 and 901. The processor 801 and 901 may include internal memory sufficient to store the application software instructions.

The foregoing method descriptions, process flow diagrams, and call flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic wireless device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication wireless devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage wireless devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of enabling short-range communications among wireless devices, comprising:
receiving by a passive sink device an encryption key, an active sink device address, and a source device address from an active sink device that has negotiated a communication link with a source device;
using the received encryption key, the received active sink device address, and the received source device address to passively receive at the passive sink device a media stream transmitted from the source device to the active sink device; and
sending information about the media stream from the passive sink device to the active sink device, wherein the information is configured to cause the active sink device to instruct the source device to take an action to improve reception of the media stream by the passive sink device.

2. The method of claim 1, wherein the information sent from the passive sink device to the active sink device configured to cause the active sink device to instruct the source device to take an action to improve reception of the media stream by the passive sink device comprises information configured to cause the active sink device to instruct the source device to increase its transmit power.

3. The method of claim 1, wherein the information sent from the passive sink device to the active sink device configured to cause the active sink device to instruct the source device to take an action to improve reception of the media stream by the passive sink device comprises information configured to cause the active sink device to instruct the source device to transmit smaller packet sizes.

4. The method of claim 1, wherein the information sent from the passive sink device to the active sink device configured to cause the active sink device to instruct the source device to take an action to improve reception of the media stream by the passive sink device comprises information configured to cause the active sink device to instruct the source device to transmit the media stream using a more robust modulation scheme.

5. The method of claim 1, further comprising rendering the media stream from the source device at the passive sink device for presentation.

6. The method of claim 1, further comprising synchronizing, between the passive and active sink devices, rendering of the media stream from the source device on each of the passive and active sink devices.

7. The method of claim 5, wherein the media stream from the source device comprises a Bluetooth media stream.

8. The method of claim 1, wherein sending information about the media stream from the passive sink device to the active sink device comprises sending an indication that a signal level of the media stream received from the source device by the passive sink device is below a signal level threshold.

9. The method of claim 1, wherein sending information about the media stream from the passive sink device to the active sink device comprises:
when a signal level of the media stream from the source device received by the passive sink device is below a threshold signal level, sending an instruction that instructs the active sink device to send a message to the source device to increase its transmit power.

10. A method of enabling short-range communications among wireless devices, comprising:
receiving by a passive sink device an encryption key, an active sink device address, and a source device address from an active sink device that has negotiated a communication link with a source device;
using the received encryption key, the received active sink device address, and the received source device address to passively receive at the passive sink device a media stream transmitted from the source device to the active sink device; and
transmitting a signal by the passive sink device configured to cause the source device to retransmit a portion of the media stream.

11. The method of claim 10, wherein the communication link negotiated between the active sink device and the source device comprises an encrypted communication link.

12. The method of claim 10, further comprising synchronizing, between the passive and active sink devices, rendering of the media stream from the source device on each of the passive and active sink devices.

13. The method of claim 10, wherein the media stream from the source device comprises a Bluetooth media stream.

14. The method of claim 13, further comprising rendering, by the passive sink device, the received Bluetooth media stream for presentation.

15. The method of claim 10, wherein transmitting by the passive sink device a signal configured to cause the source device to retransmit a portion of the media stream comprises transmitting a pattern by the passive sink device configured to corrupt an ACK pattern transmitted by the active sink device.

16. The method of claim 10, wherein transmitting a signal by the passive sink device configured to cause the source device to retransmit a portion of the media stream comprises sending information about the media stream from the passive sink device to the active sink device, wherein the information is configured to cause the active sink device to instruct the source device to retransmit a portion of the media stream.

17. The method of claim 16, wherein sending information about the media stream from the passive sink device to the active sink device comprises sending an indication that the passive sink device is not receiving at least a threshold portion of the media stream.

18. The method of claim 16, wherein sending information about the media stream from the passive sink device to the active sink device comprises sending an instruction configured to cause the active sink device to send a message to the source device to retransmit a portion of the media stream when a portion of the media stream received from the source device by the passive sink device is below a threshold level of portions of the media stream.

19. The method of claim 16, wherein the instruction is configured to cause the active sink device to transmit a NACK message to the source device regardless of whether the active sink device received the portion of the media stream.

20. The method of claim 16, wherein sending information about the media stream from the passive sink device to the active device comprises sending a NACK message to the active sink device.

21. A computing device, comprising:
a wireless transceiver; and
a processor coupled to the wireless transceiver and configured with processor-executable instructions to perform operations comprising:
receiving an encryption key, an active sink device address, and a source device address from an active sink device that has negotiated a communication link with a source device;
using the received encryption key, the received active sink device address and the received source device address to passively receive a media stream transmitted from the source device to the active sink device; and
sending information about the media stream to the active sink device, wherein the information is configured to cause the active sink device to instruct the source device to take an action to improve reception of the media stream by the passive sink device.

22. The computing device of claim 21, wherein the processor is configured with processor-executable instructions to perform operations such that the information sent to the active sink device configured to cause the active sink device to instruct the source device to take an action to improve reception of the media stream by the passive sink device comprises information configured to cause the active sink device to instruct the source device to increase its transmit power.

23. The computing device of claim 21, wherein the processor is configured with processor-executable instructions to perform operations such that the information sent to the active sink device configured to cause the active sink device to instruct the source device to take an action to improve reception of the media stream by the passive sink device comprises information configured to cause the active sink device to instruct the source device to transmit smaller packet sizes.

24. The computing device of claim 21, wherein the processor is configured with processor-executable instructions to perform operations such that the information sent to the active sink device configured to cause the active sink device to instruct the source device to take an action to improve reception of the media stream by the passive sink device comprises information configured to cause the active sink device to instruct the source device to transmit the media stream using a more robust modulation scheme.

25. The computing device of claim 21, wherein the processor is configured with processor-executable instructions to perform operations such that sending information about the media stream from the passive sink device to the active sink device comprises sending an indication that a signal level of the media stream received from the source device by the passive sink device is below a signal level threshold.

26. The computing device of claim 21, wherein the processor is configured with processor-executable instructions to perform operations such that sending information about the media stream from the passive sink device to the active sink device comprises when a signal level of the media stream from the source device received by the passive sink device is below a threshold signal level, sending an instruction that instructs the active sink device to send a message to the source device to increase its transmit power.

27. A computing device, comprising:
a wireless transceiver; and
a processor coupled to the wireless transceiver and configured with processor-executable instructions to perform operations comprising:
receiving an encryption key, an active sink device address, and a source device address from an active sink device that has negotiated a communication link with a source device;
using the received encryption key, the received active sink device address, and the received source device address to passively receive a media stream transmitted from the source device to the active sink device; and
transmitting a signal configured to cause the source device to retransmit a portion of the media stream.

28. The computing device of claim 27, wherein the processor is configured with processor-executable instructions to perform operations such that transmitting a signal configured to cause the source device to retransmit a portion of the media stream comprises transmitting a pattern configured to corrupt an ACK pattern transmitted by the active sink device.

29. The computing device of claim 27, wherein the processor is configured with processor-executable instructions to perform operations such that transmitting a signal configured to cause the source device to retransmit a portion of the media stream comprises sending information about the media stream from the passive sink device to the active sink device, wherein the information is configured to cause the active sink device to instruct the source device to retransmit a portion of the media stream.

30. The computing device of claim 29, wherein the processor is configured with processor-executable instructions to perform operations such sending information about the media stream from the passive sink device to the active sink device comprises sending an indication that the passive sink device is not receiving at least a threshold portion of the media stream.
